(19) United States
(12) Patent Application Publication
(10) Pub. No.: US 2015/0040661 A1
(43) Pub. Date: Feb. 12, 2015

(54) Extensometer Probe and System for Monitoring Displacement, Water Level and Evaporation

(71) Applicant: Michael A. Olson, Ann Arbor, MI (US)

(72) Inventor: Michael A. Olson, Ann Arbor, MI (US)

(21) Appl. No.: 13/964,098

(22) Filed: Aug. 11, 2013

(51) Int. Cl. G01F 23/60

(52) U.S. Cl. CPC G01F 23/60
USPC 73/313

(57) ABSTRACT

An extensometer probe comprising a linear variable differential transformer (LVDT) and a novel coaxial clamp and extension tube; useful for reducing thermal error, precisely measuring displacement, and deployment in tight spaces like wells or boreholes. A novel float for measuring free surface elevation of liquid; comprising an autonomous vibrator for reducing effects of bubbles, surface tension, and friction. An embodiment of the probe for measuring convergence or dilation in tunnels, bridges, buildings, etc. Embodiments of the probe and float for measuring water level: a total probe for measuring from a single point directly beneath the float, and an evaporation probe for measuring within a hydraulically isolated evaporation pan. A novel mobile monitoring platform deploys the probes within an impoundment, lagoon, pond or other environmental containment structure. A system comprising the total and evaporation probes and electronics for directly measuring seepage, or specific discharge, from animal waste or manure lagoons.

This patent application and specification claims the benefit of my provisional application No. 61/742,414, filed Aug. 11, 2012.

A portion of the disclosure of this patent document contains material that is subject to copyright protection. The owner has no objection to the facsimile reproduction by anyone of the patent document or the patent disclosure, as it appears in the Patent and Trademark Office patent file or records, but otherwise reserves all copyright rights.

### 1. BACKGROUND OF THE INVENTION

This specification pertains to electromechanical instrumentation, specifically precision measurement and monitoring of linear position and displacement. The novel features disclosed herein are useful for precise monitoring of displacement over relatively long distances, under varying temperatures, and in tight spaces. Applications include monitoring of convergence or dilation on tunnels, bridges, buildings or other structures. Two embodiments are particularly useful for monitoring water level and evaporation to assess the hydraulic performance of environmental containment structures.

In this specification the term “extensometer” refers to an instrument for measuring minute change in distance between two points that are relatively far apart. The change in distance is referred to as displacement.

The extensometer works by extending the reach of a displacement-measuring device having high precision but a necessarily small working range. Such a device may be a known linear variable differential transformer (LVDT) and attendant electronics with ultimate precision on the order of 0.1% of range. For example an extensometer may be used to span a relatively large distance between the roof and floor of a tunnel, to measure displacement using a LVDT, with 0.001″ ultimate precision over 1″ range and stable ambient temperature.

General considerations in the design of an LVDT extensometer and related system are ease of use, ultimate precision, and monitoring and recoding of displacement over time. Specific challenges include practical mounting of the LVDT and deployment of the extensometer, and dimensional stability over long distance and varying ambient temperature.

Use of an extensometer for precision monitoring of water level with a lightweight float connected to the core of a LVDT presents another challenge. That is to overcome stiction, or the subtle friction between the core and bore of the LVDT. Stiction resists slight forces of buoyancy or weight, and motion of the float during minute changes in water level.

### 2. BRIEF SUMMARY OF THE INVENTION

This specification teaches of a novel and useful extensometer probe and system for practical and precise monitoring of displacement, water level and evaporation. The probe is packaged into a compact, coaxial form that is useful in tight and remote places. It is very precise and stable over relatively long distances and wide ranging ambient temperature.

The probe kernel sends an electrical signal that varies with distance according to a known, characteristic relationship. A monitoring unit periodically samples the signal, calculates relative distance, records the result and time; and provides electrical power to the probe kernel. Additional functions of the monitoring unit include calculation of displacements and rates, channels for other probe kernels, and channels for monitoring temperatures and other environmental parameters relevant to the observation.

The device and system includes novel features that adapt the probe kernel to the application of precise and practical monitoring of water level. These features are also packaged in a novel coaxial probe to form the “probe kernel for water level”. This is the platform for two other novel coaxial probes called the “total probe” and the “evaporation probe”.

The total probe monitors total displacement of water level with respect to a fixed reference point beneath the water level of an environmental containment structure. Simultaneously, the evaporation probe monitors displacement of water level within an open pan that is hydraulically isolated but suspended and partially submerged into the surface of the same water body as the total probe.

These probes and system are particularly useful for non-invasive testing of the actual gross hydraulic performance of environmental containment structures. They provide for nearly continuous, rapid and direct monitoring of water levels that can be used to analyze seepage through the liner system. The high level of precision produces meaningful results within a few hours, useful for comparison to minute regulatory limits. This is important when there is limited time to isolate the containment structure and perform the test. A novel “dock trailer” provides for practical deployment and use of these probes from the shore of open water structures where it is otherwise difficult to safely access the water surface.

The subject device and system therefore answers a long known but unfulfilled need for rapid, direct and practical performance testing of environmental containment structures. This is an economically and practically attractive alternative to the conventional invasive practice of sampling and testing of liner materials, and engineering analysis to predict performance. Performance testing may also be useful for evaluation and validation of predictive models.

The evaporation probe can also monitor evaporation on land, either suspended or sitting on a surface. It can be configured to monitor evaporation within a recognized pan such as a NWS Class A (Hargreaves) pan. This promises a leap in precision of practical evaporation measurement with obvious benefits to environmental sciences.

The displacement probe may be adapted to a variety of other uses that require precise and practical monitoring of displacement. It is useful for monitoring minute displacements in any orientation with respect to a relatively distant, fixed reference point. Some examples include convergence, dilation and strain in structures, bulk strain in structural members, and precise positioning of large parts and machinery.

The probe kernel for water level and the total probe may be adapted to monitoring of any free surface of a liquid body that is at least one foot deep. Some examples include fresh water storage; ponds, lakes and streams; water, oil and gas wells; and fuel, process and product tanks.

The dock trailer may be adapted to provide temporary, safe personnel access from the shore, to the surface of an of a variety of open water bodies any other purpose. Some examples are other kinds of monitoring, sampling, and installation and removal of pumps and other equipment.

### 3. BRIEF DESCRIPTION OF THE DRAWINGS

The following drawings shall accompany this specification. The drawings show the devices in vertical orientation for convenience only. Other orientations are possible. All projections are orthogonal.

3.1. Formal Drawings

### SHEET 1

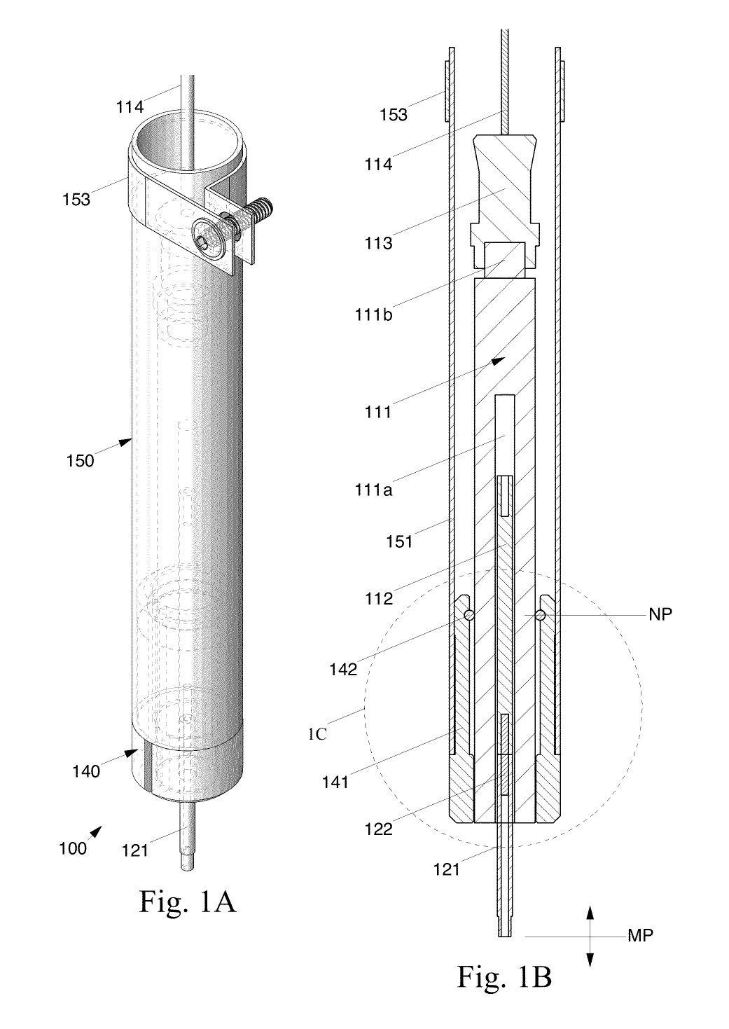

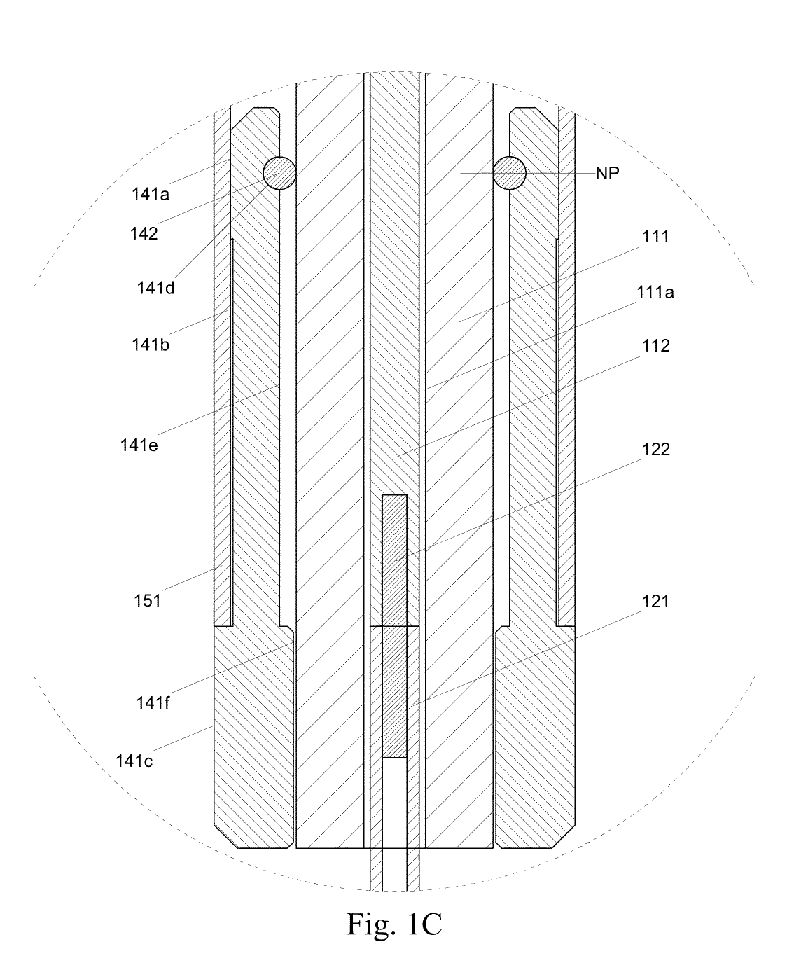

FIG. 1A is a right isometric view of the extensometer probe 100.

FIG. 1B is a front section view of extensometer probe 100.

### SHEET 2

FIG. 1C is an enlarged front section view of the bottom part of the extensometer probe 100, showing detail of coaxial ring clamp assembly 140.

### SHEET 3

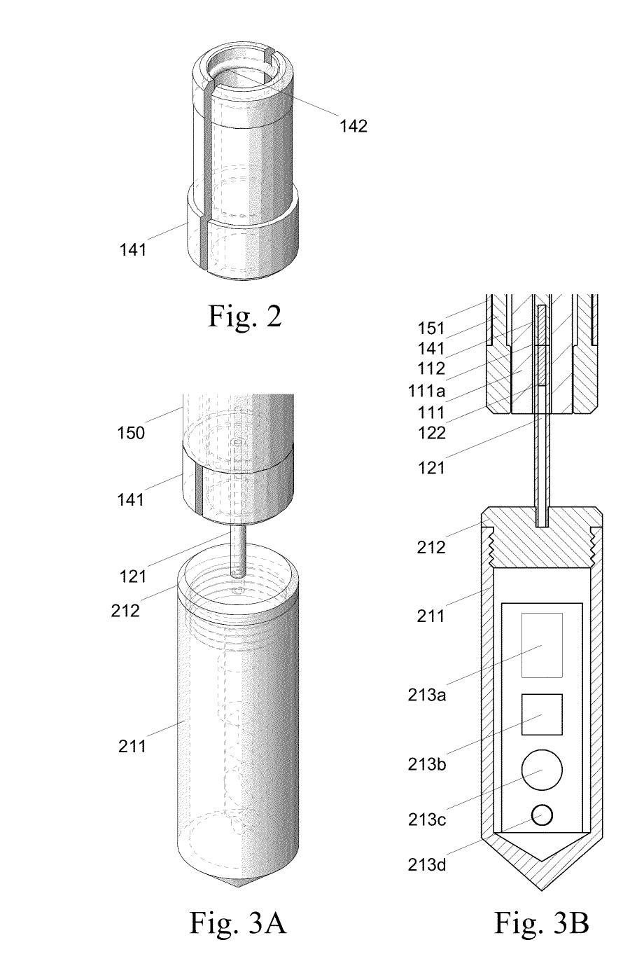

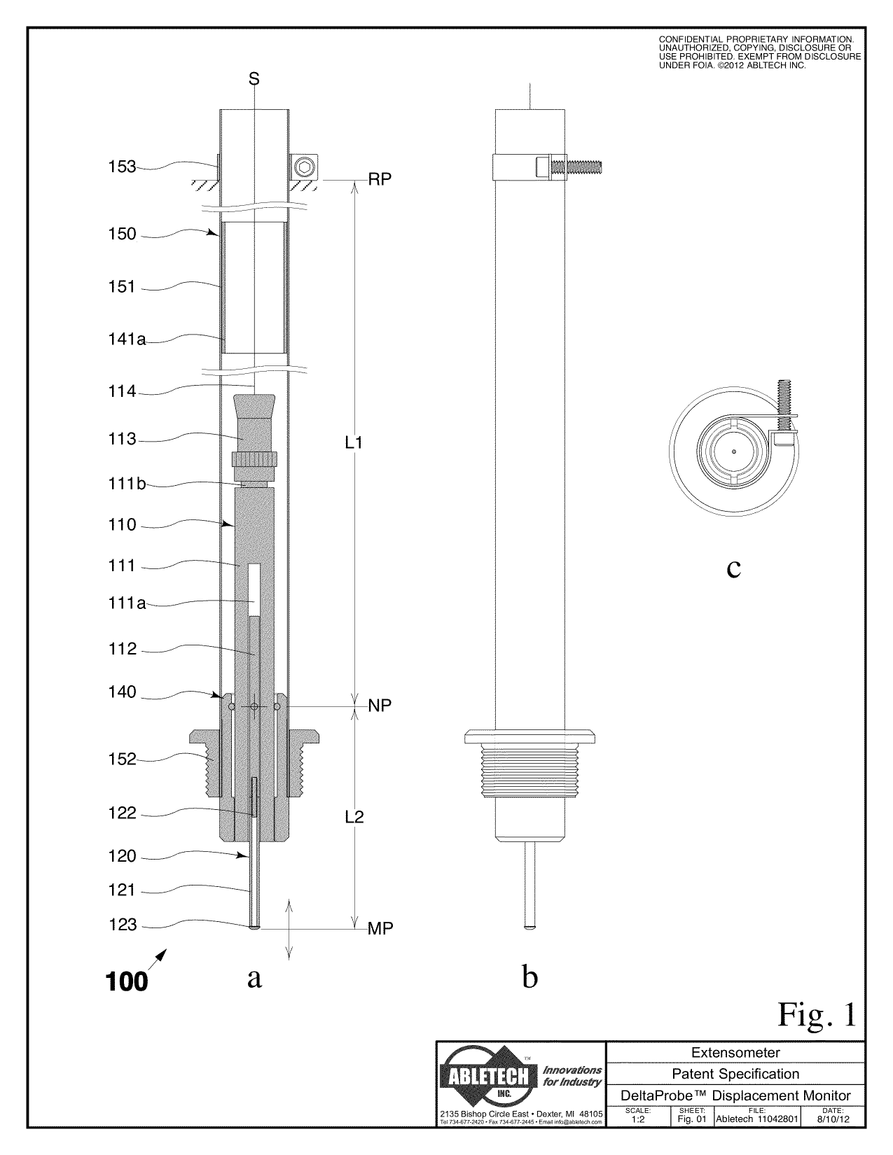

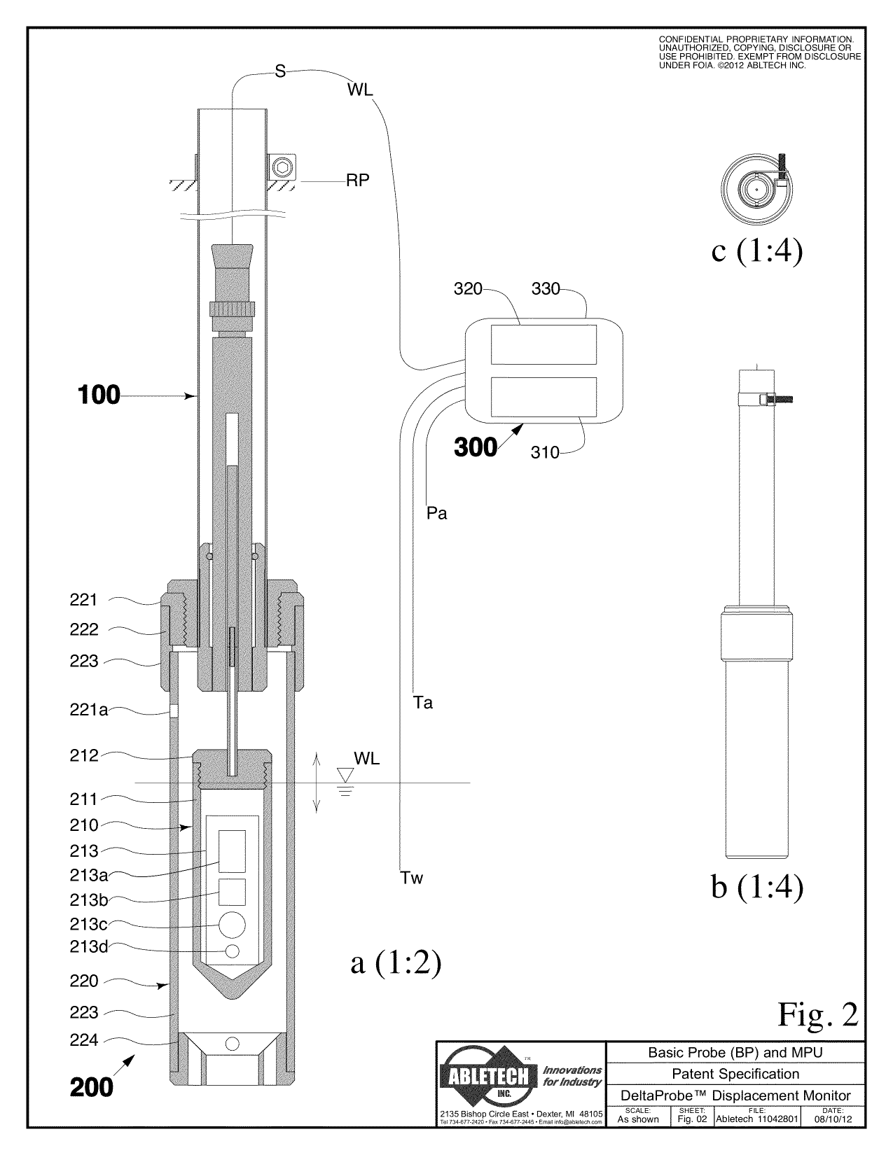

FIG. 2 is a right isometric view of coaxial ring clamp assembly 140.

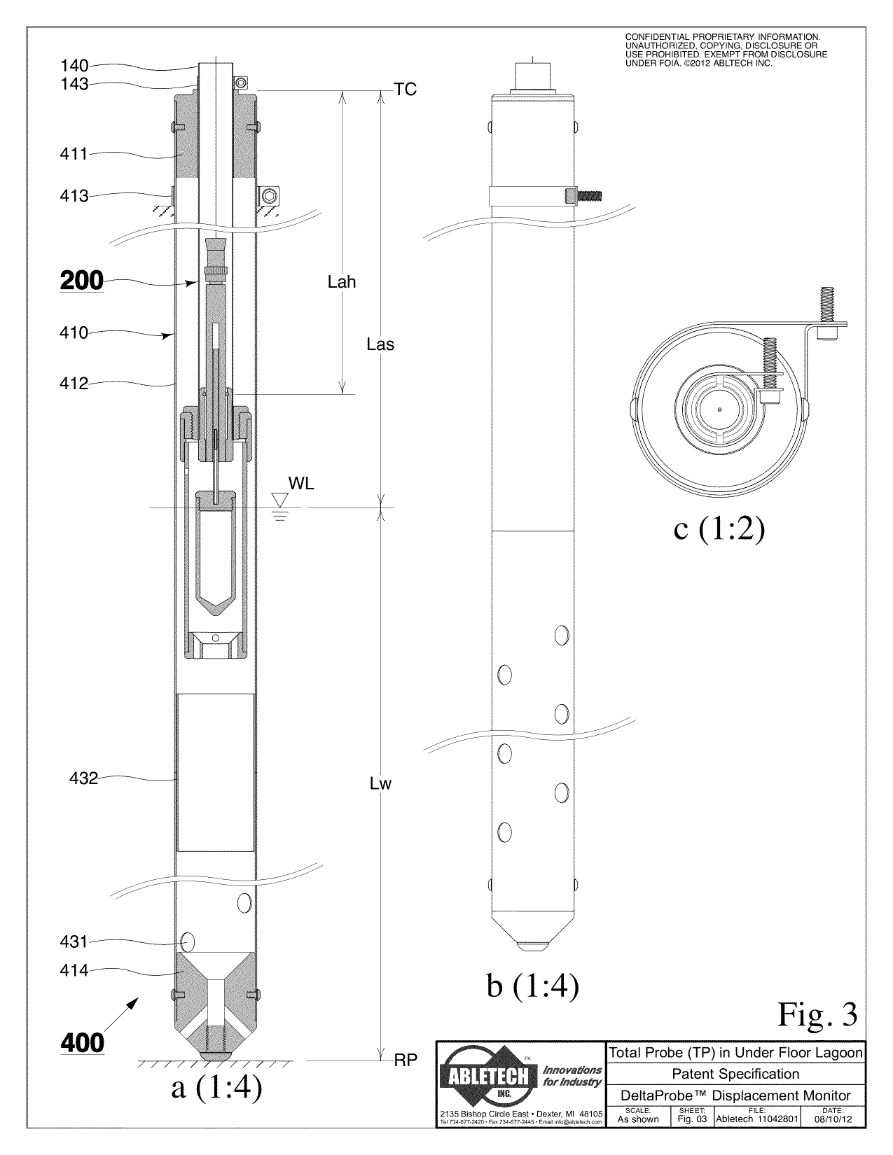

FIG. 3A is a right isometric view of float assembly 210 together with the bottom end of extensometer probe 100.

FIG. 3B is a front section view of float assembly 210 together with the bottom end of extensometer probe 100.

3.2. Informal Drawings Submitted with PPA, to be Formalized

The following scale drawings shall accompany this specification. Dimensions are evident from the drawings. The drawings are hard copies of CAD files in electronic format with a resolution of 0.0005″. The drawings show the device in vertical orientation for convenience only. Other orientations may be possible.

For simplicity the entire signal cable 114, autonomous vibrator 213, and MPU are only shown in FIG. 2 although they are used in the applications of the other drawings. In this provisional specification, references in the text may not appear in the drawings, and vice versa.

FIG. 1—Extensometer
a. Front vertical section through center
b. Right side view
c. Top view

FIG. 2—Basic Probe (BP) and MPU
a. Front vertical section through center of probe, and schematic of MPU
b. Right side view
c. Top view

FIG. 3—Total Probe (TP) In Under Floor Lagoon
a. Front vertical section through center
b. Right side view
c. Top view

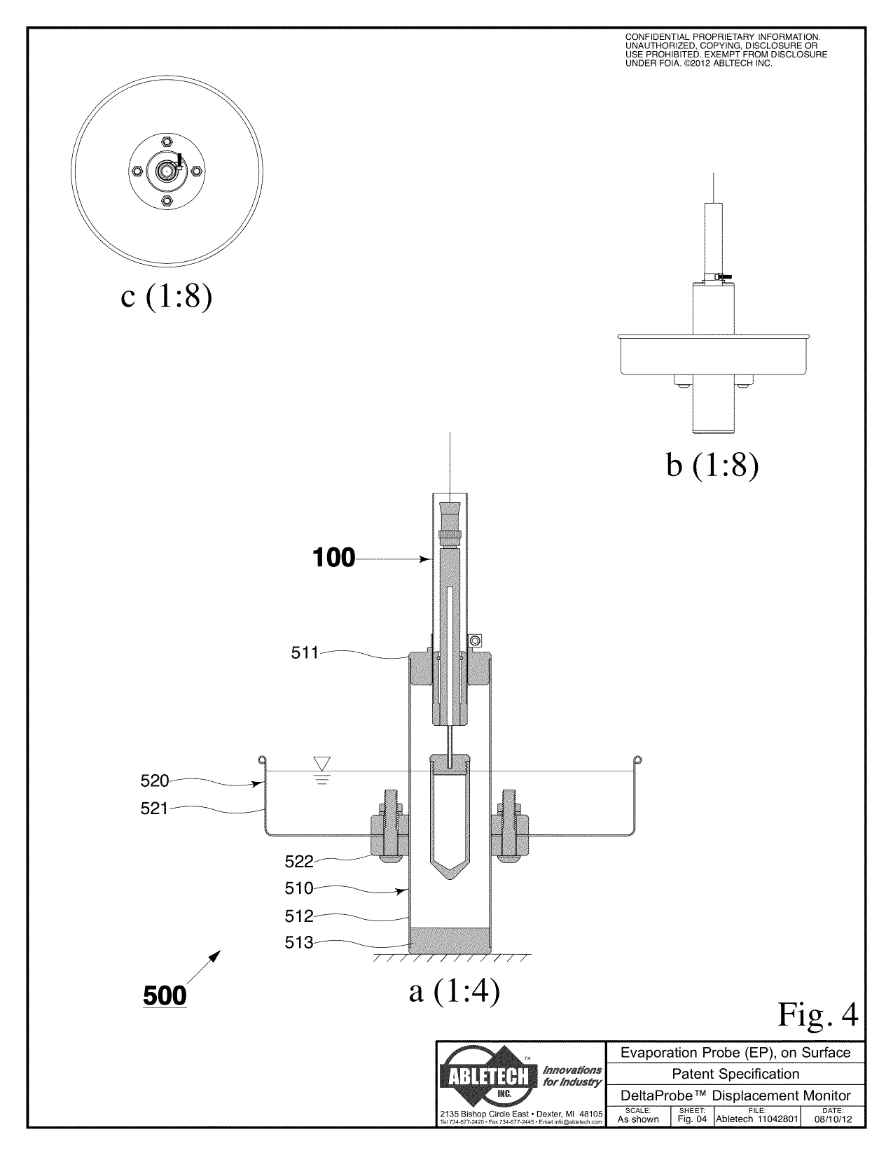

FIG. 4—Evaporation Probe (EP), on Surface
a. Front vertical section through center
b. Right side view
c. Top view

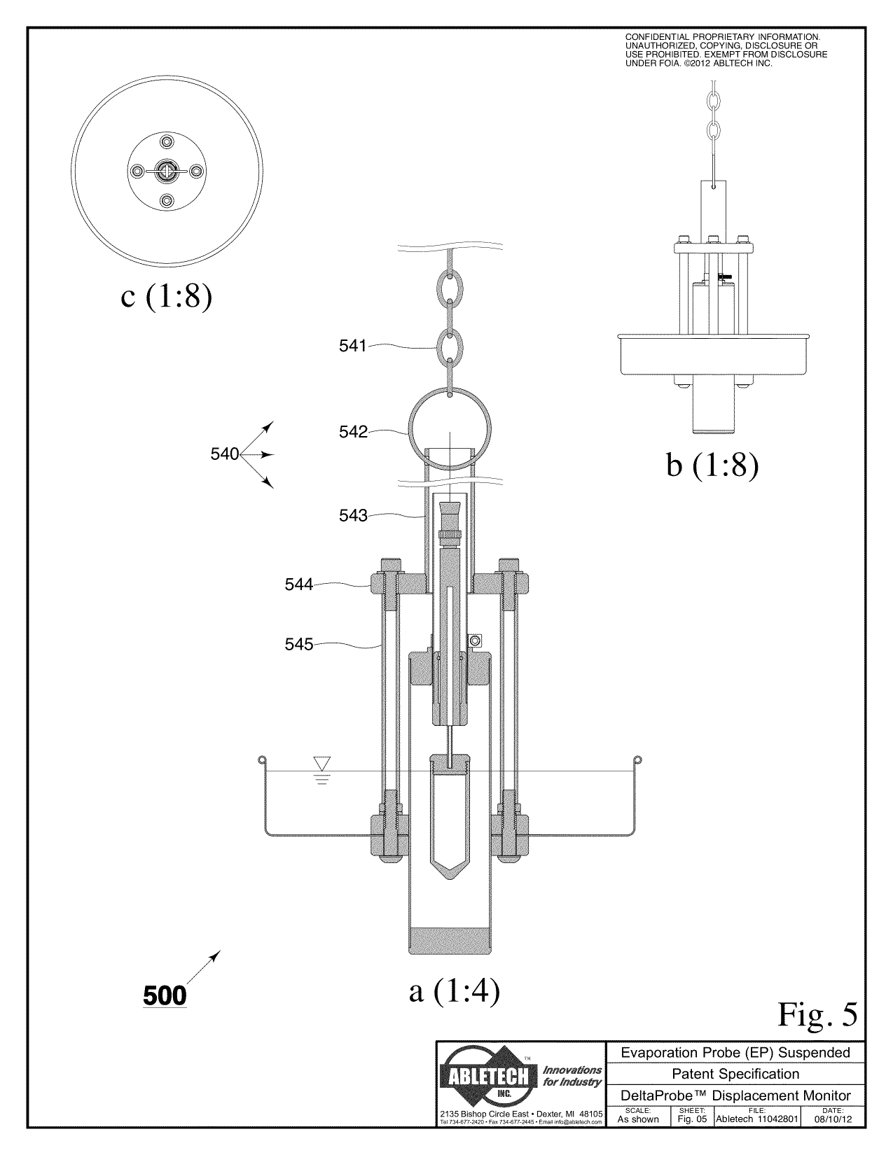

FIG. 5—Evaporation Probe (EP), Suspended
a. Front vertical section through center
b. Right side view
c. Top view

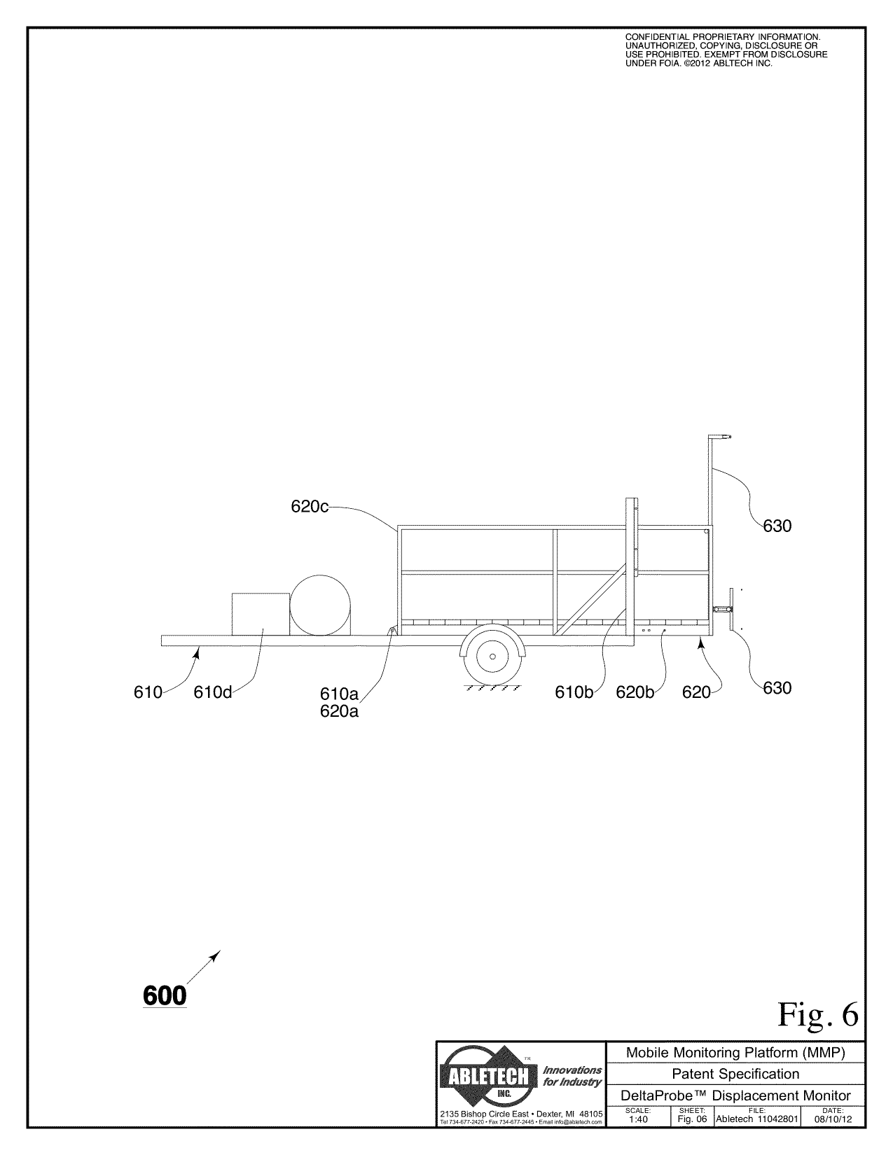

FIG. 6—Mobile Monitoring Platform (MMP)
Side elevation

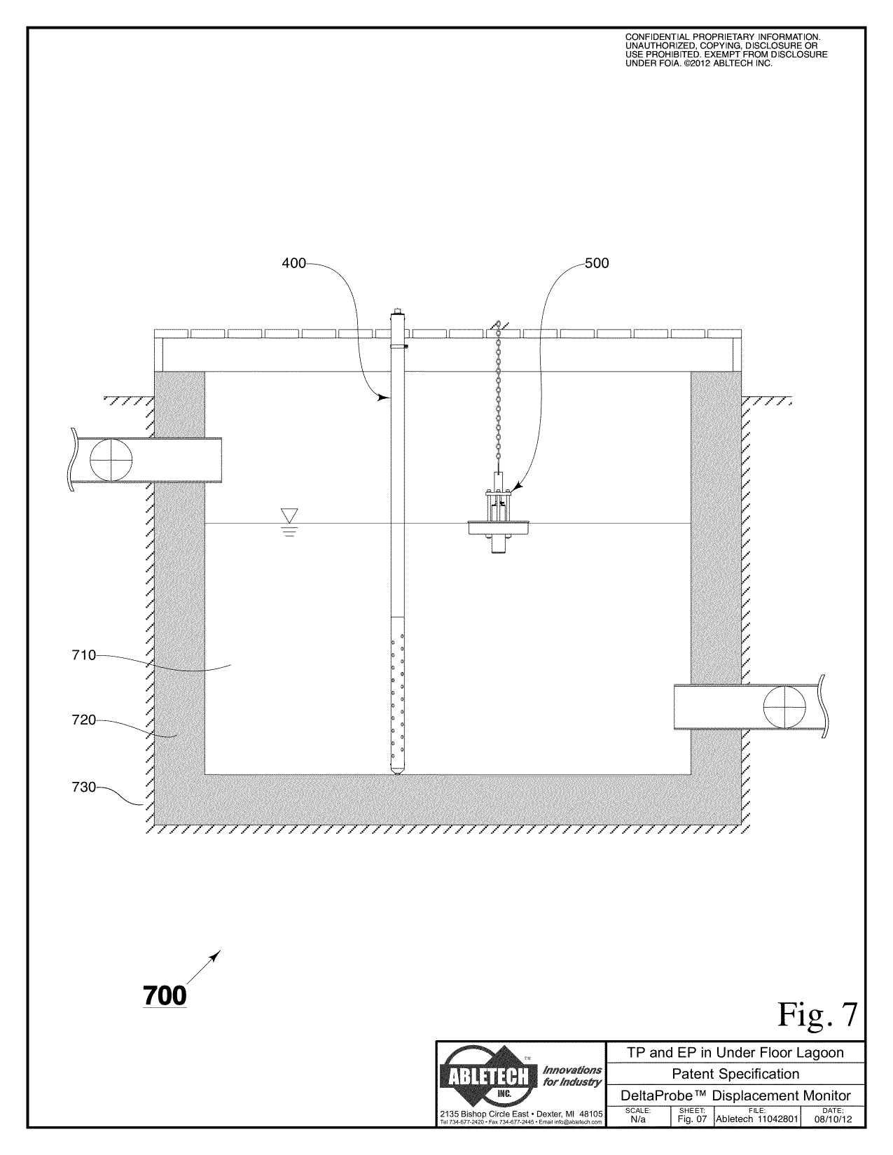

FIG. 7—TP and EP in Under Floor Lagoon
Front elevation

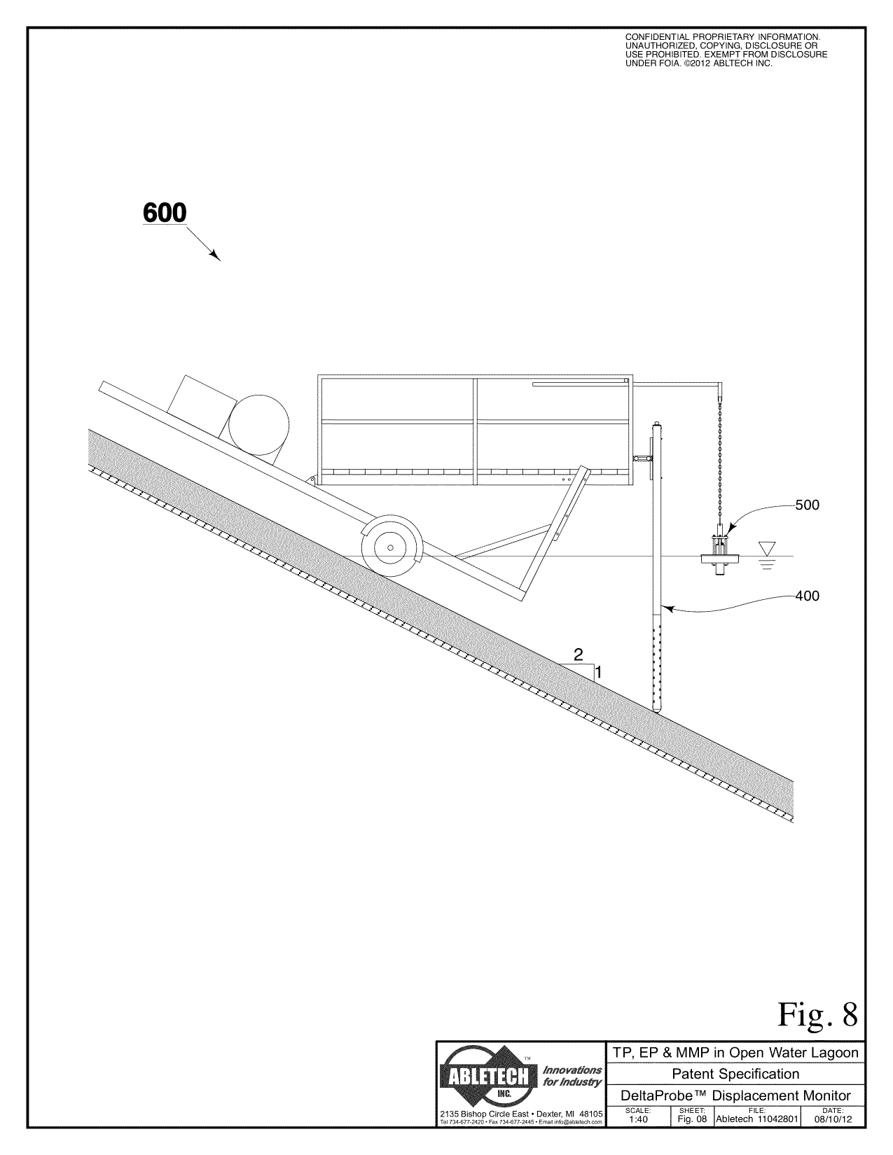

FIG. 8—TP, EP & MMP in Open Water Lagoon
Front elevation

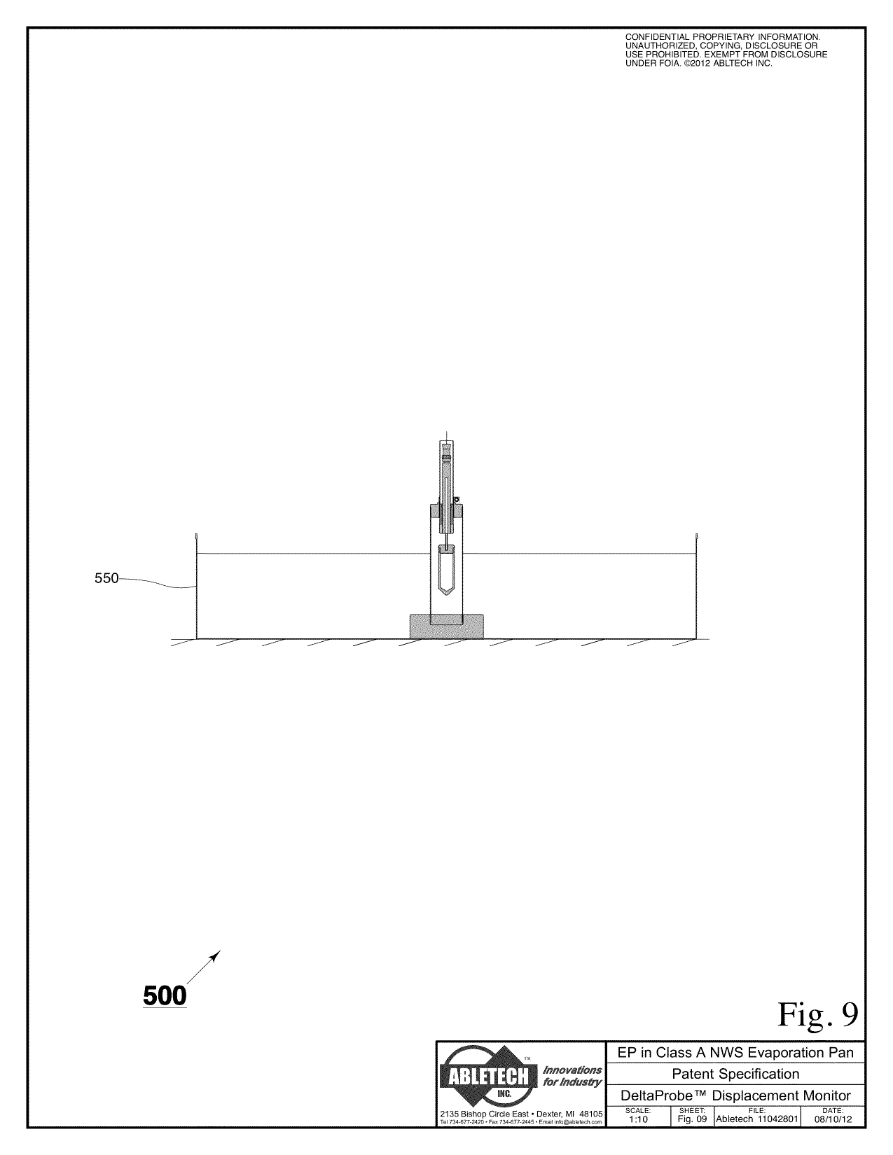

FIG. 9—EP in Class A NWS Evaporation Pan
Front vertical section through center

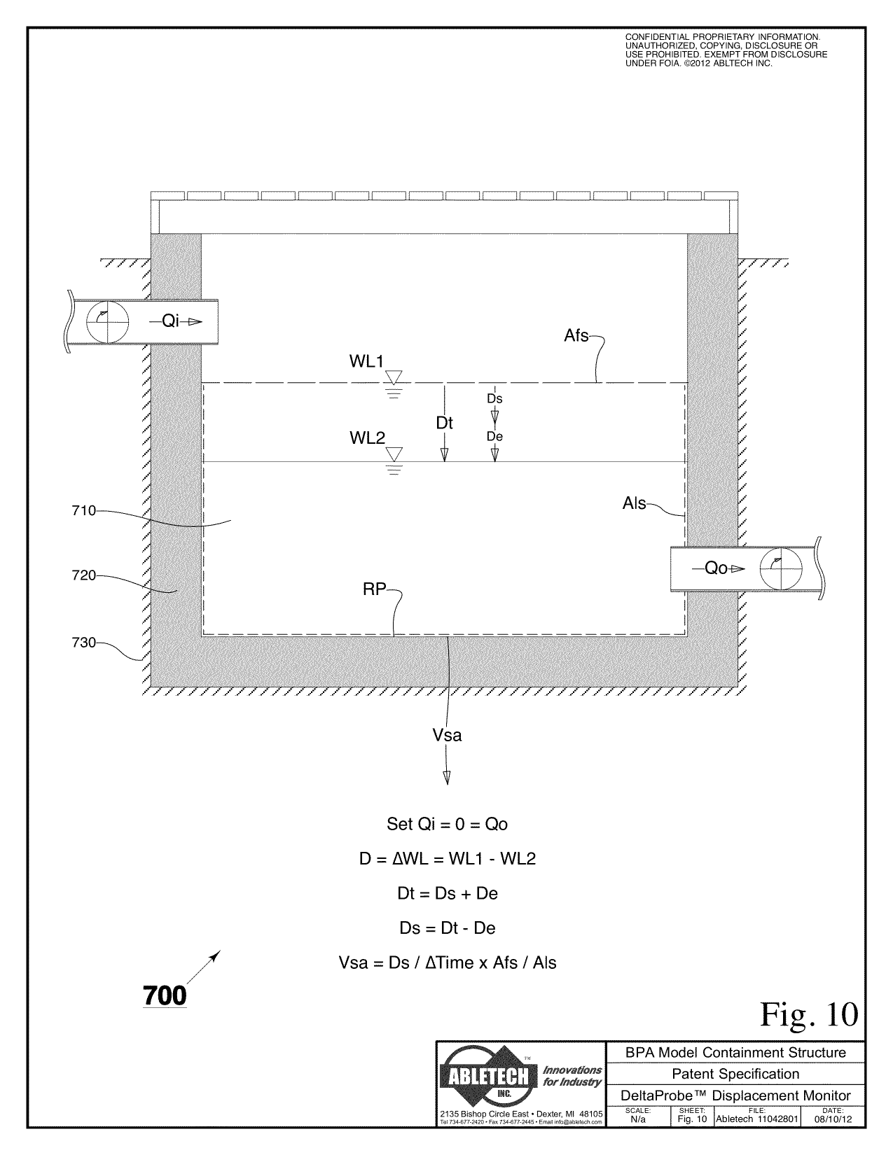

FIG. 10—Model Containment Structure
Front elevation

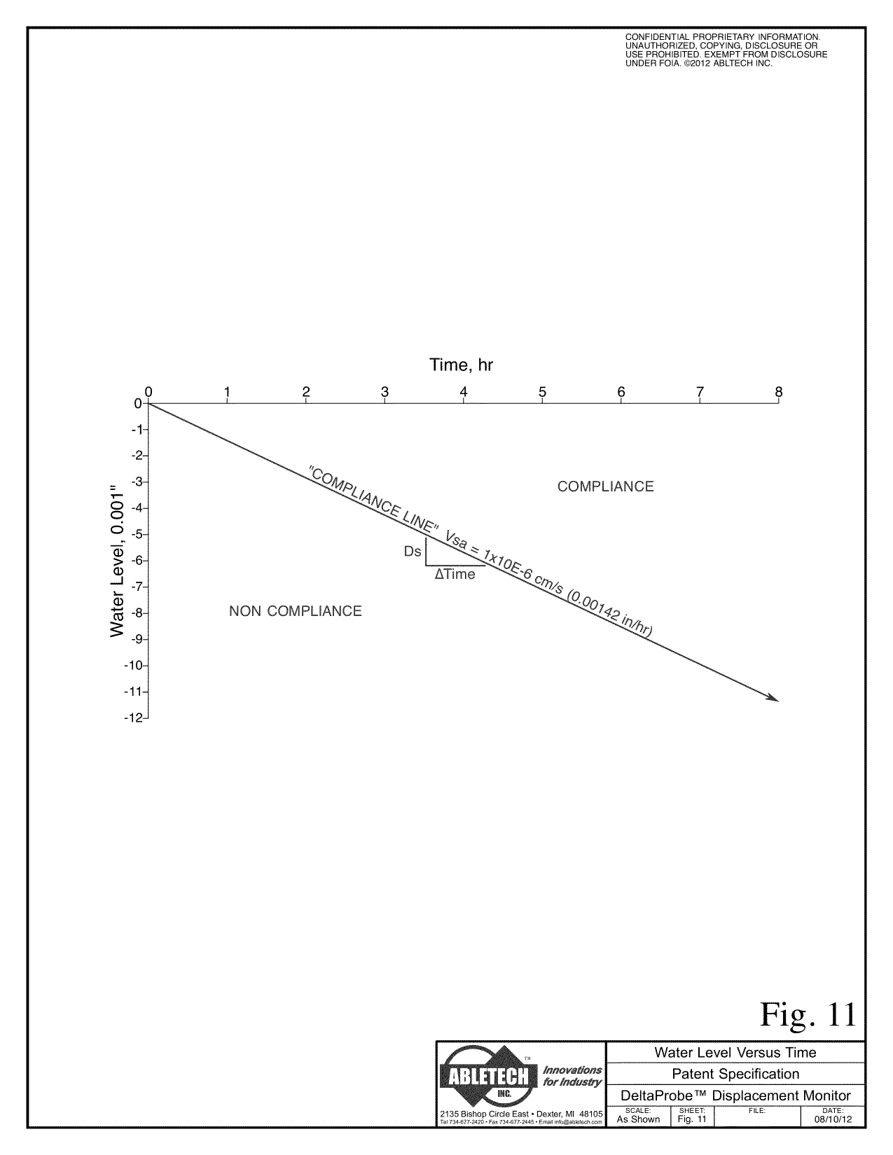

FIG. 11—Water Level Versus Time
Graph

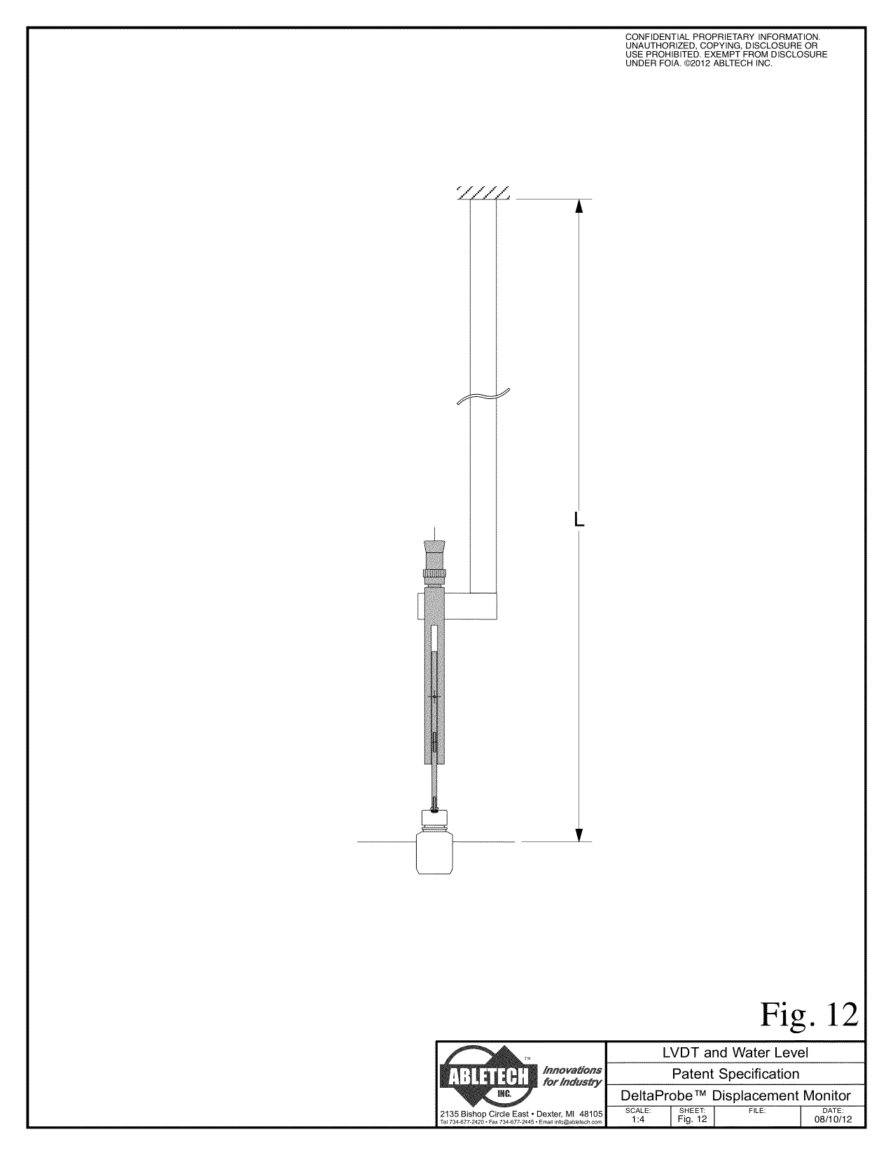

FIG. 12—LVDT and Water Level

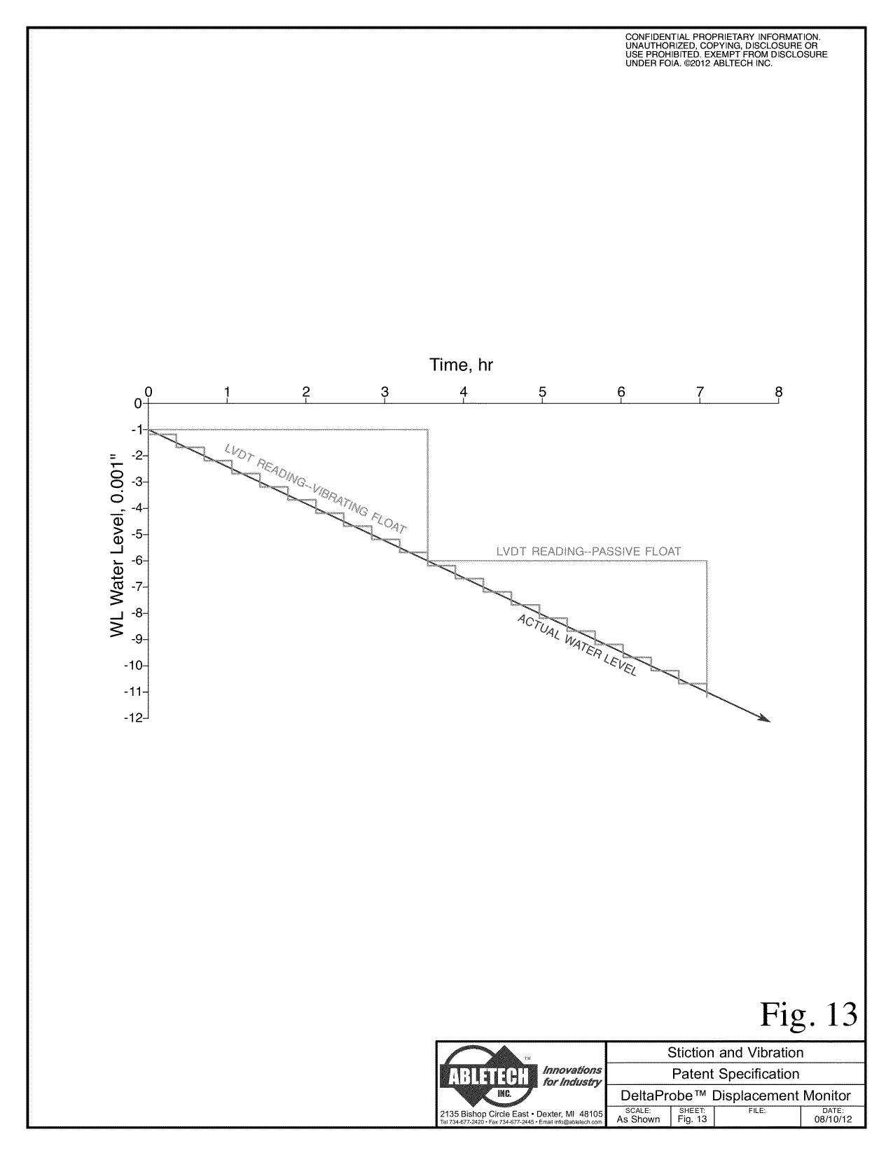

FIG. 13—Stiction and Vibration
Graph

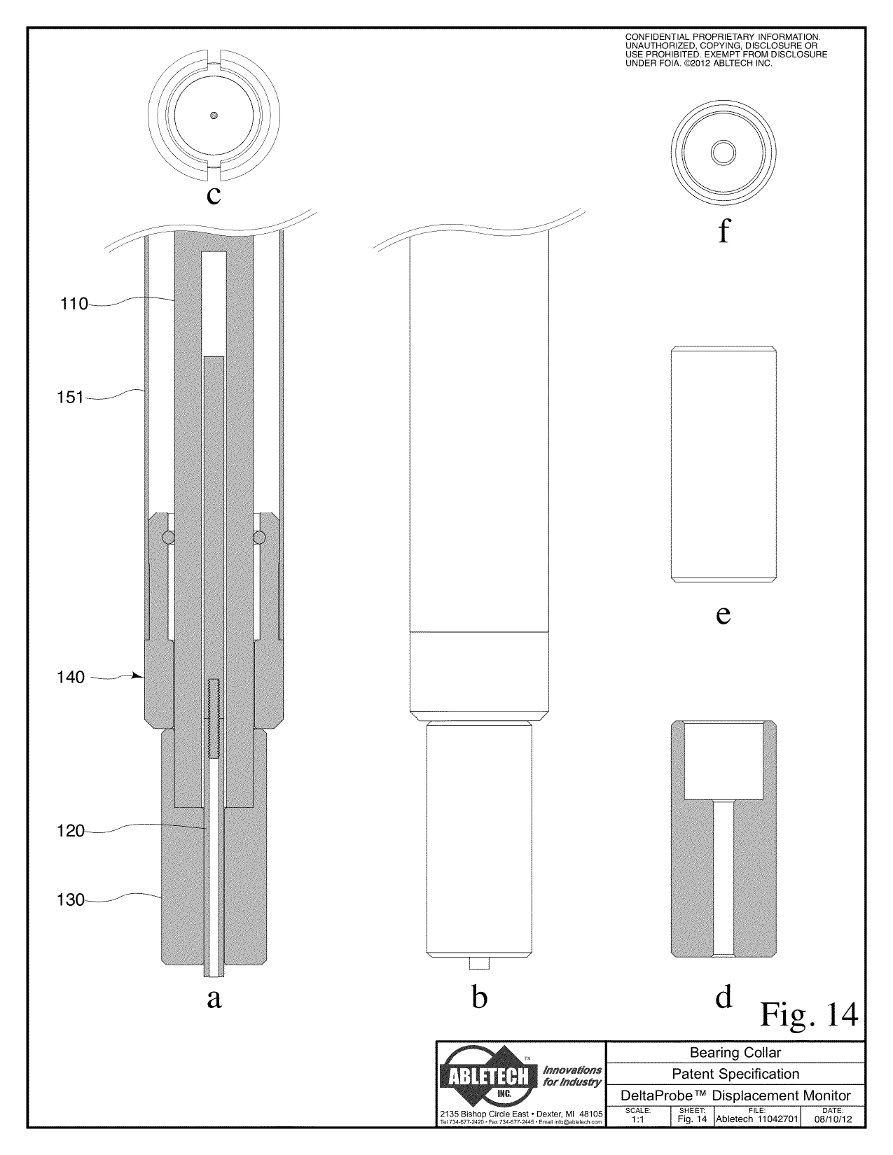

FIG. 14—Bearing Collar
Together with connecting rod 120, LVDT 110, coaxial ring clamp 140, and extension tube 151:
a. Front vertical section through center
b. Right side view
c. Top view
Alone:
d. Front vertical section through center
e. Right side view
f. Top view

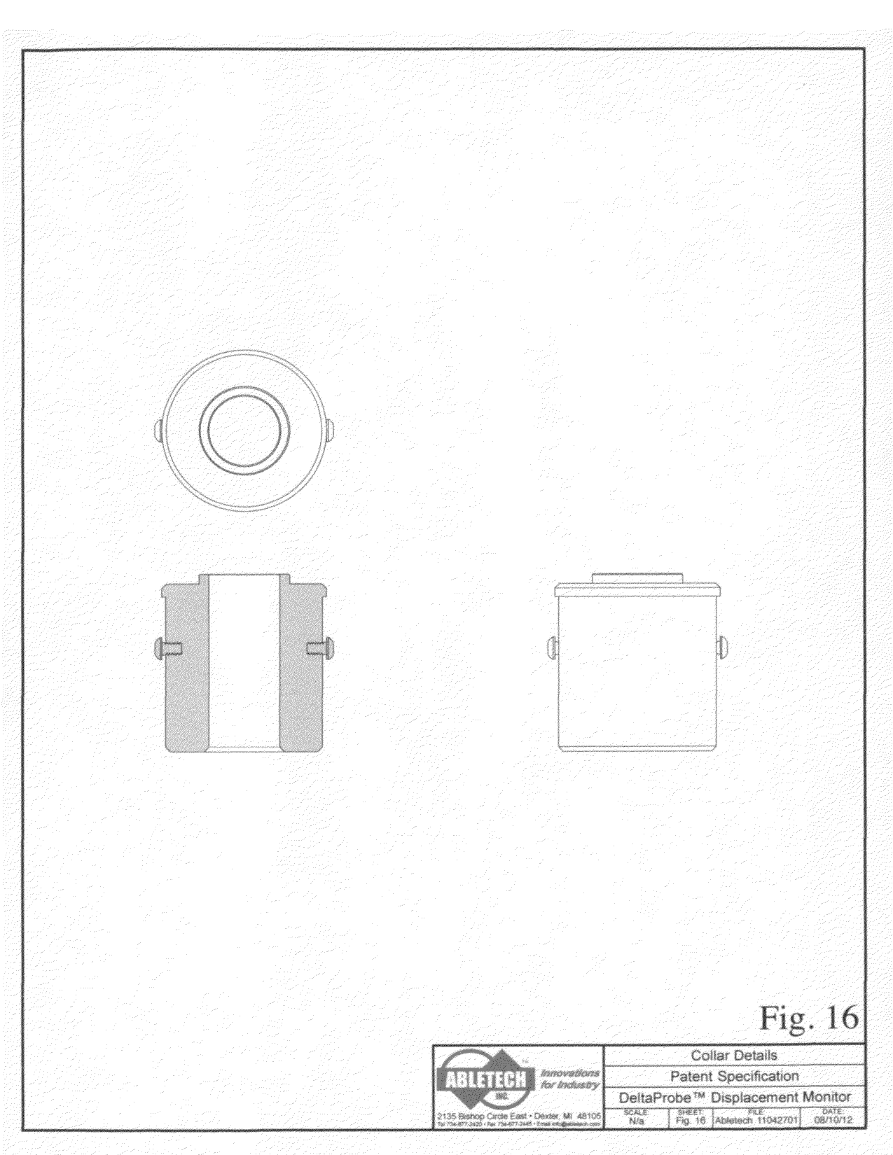

FIG. 16—Collar details

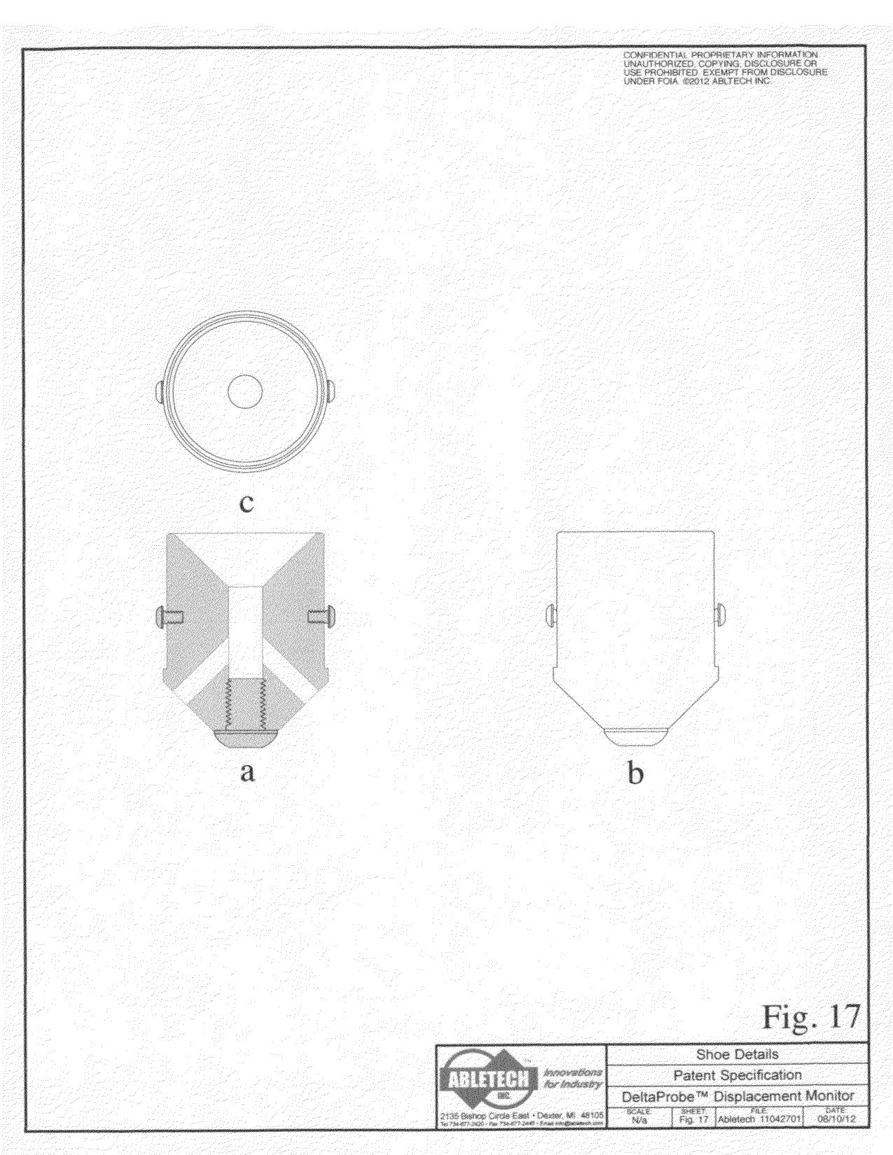

FIG. 17—Shoe details.

### 4. ALPHANUMERIC REFERENCES AND DEFINITIONS

100. Extensometer
   110. Known linear variable differential transducer (LVDT) assembly
      111. Coil assembly
         a. Bore
         b. Jack
         NP=Null point (midrange point)
      112. Core
         a. Threaded end
      113. Plug
      114. Signal cable
   120. Connecting rod assembly
      121. Tube
      122. Threaded stud
      123. Tip (optional)
   130. Bearing Collar (optional)
   140. Coaxial ring clamp assembly
      141. Split shell (two opposing halves)
         a. Outside top shoulder
         b. Outside recess
         c. Outside bottom shoulder
         d. Inside recess
         e. Inside top surface
         f. Inside shoulder
      142. O-ring
   150. Extension assembly
      151. Tube
         a. Ferrule (optional)
      152. Reducer bushing (optional)
      153. Loop clamp assembly
200. Basic Probe
   210. Float assembly
      211. Vessel
      212. Cap
         a. Hole
      213. Autonomous vibrator assembly
         a. Battery
         b. Control circuit
         c. Motor
         d. Power light
   220. Housing assembly (optional)
      221. Reducer bushing
      222. Coupling
      223. Tube
         a. Vent hole
      224. Inlet cap
         a. Inlet hole
         b. Drain holes
300. Monitoring and power Unit (MPU)
   310. Data logger
   320. Power supply
   330. Field case
400. Total probe (TP)
   410. Support assembly
      411. Collar
         a. Landing
         b. Shoulder
         c. Outside surface
         d. Inside surface
         e. Tapped hole(s) (optional)
         f. Machine screw(s) (optional)
      412. Tube
         a. Clearance holes(s) for machine screws 411f
         b. Ferrule (optional)
         c. Equalizer hole(s)
         d. Clearance hole(s) for machine screws 414
      413. Loop Collar
      414. Shoe
         a. Outside surface
         b. Shoulder
         c. Inside surface
         d. Large tapped hole
         e. Tip
         f. Drain hole(s) optional
         g. Small tapped hole(s) (optional)
         h. Machine screw(s) (optional)
500. Evaporation probe (EP)
   510. Support assembly
      511. Collar
         a. Landing for loop clamp 143
         b. Top outside surface
         c. Bottom outside surface
         d. Inside surface
      512. Tube
         a. Equalizer hole(s)
      513. Shoe
   520. Pan assembly (optional)
      521. Pan proper
         a. Rim
         b. Clearance hole for tube
         c. Clearance hole for machine screws
      522. Flanges
         a. Clearance hole for tube
         b. Clearance holes for machine screws
         c. Machine screws, washers and nuts
   530. Base (optional)
   540. Hanger assembly (optional)
      541. Cable, chain or rope (optional)
      542. Split ring (optional)
      543. Tube
         a. Holes for split ring (optional)
         b. Threaded end
      544. Flange
         a. Tapped hole
         b. Clearance holes
         c. Screws and washers
      545. Connecting rods
   550. Known Hargreaves Class A NWS evaporation pan
   560. Bailer
      561. Check valve
         a. Activator rod
      562. Nipple
      563. Shoe
      a. Tapped hole
      564. Tube
         a. Overflow/vent holes
         b. Clearance holes (optional)
      564. Collar
         a. Tapped hole for hanger tube
         b. Tapped hole(s) for machine screws (optional)
         c. Machine screws (optional)
      565 Hanger Tube
         a. Holes for split ring
      566. Split ring
      567. Chain or rope
600. Mobile Monitoring Platform (MMP)
   610. Trailer
      a. Hinge point
      b. Support post(s)
      c. Tank, pump and hose for decon (optional)
      d. Tool box (optional)
   620. Deck
      a. Hinge point
      b. Support bracket(s)
      c. OSHA railing
   630. Bracket for total probe 400
   640. Hanging arm
700. Model containment structure
   710. Water
   720. Liner system
   730. Surrounding soil, groundwater and environment
   Afs=Area, free surface
   Als=Area, wetted liner surface
   Dt=Displacement of water level, total
   De=Displacement of water level, evaporation
   Ds=Displacement of water level, seepage
   Qi.=Known inflows
   Qo=Known outflows
   WL1=Water level 1
   WL2=Water level 2
800. Known float, LVDT, support
   710. Float
   720. Connecting rod
   730. LVDT
   740. Support
L1=Length of extension tube from reference point RP to null point NP
L2=Length of core and connecting rod from null point NP to measured point MP
Lae=Length of extension assembly 140 from top of collar TC to water level WL
Las=Length of support assembly 410 in air, from water level WL to top of collar TC
Lw=Length of support assembly 410 in water, from reference point RP to water level WL
MP=Measured point
Pa=Other ambient parameters
RP=Reference point
S=Electrical signal in correlation with position of measured point MP
Ta=Air temperature
Tw=Water temperature
TC=Top of collar
WL=Water level

### 5. DETAILED DESCRIPTION OF THE INVENTION

### 5.1. Extensometer

An extensometer is a known instrument for measuring minute changes in distance between two relatively distant points. This change in distance is referred to as displacement. FIG. 1 shows novel extensometer 100. This extensometer uses a known linear variable transformer (LVDT) 110 together with a novel coaxial ring clamp 140, novel extension 150, novel connecting rod 120 and optional novel bearing collar 130 to measure displacement between a reference point RP and a measured point MP.

5.1.1. Coaxial Ring Clamp

The novel coaxial ring clamp 140 is a means to coaxially mount LVDT 110, holding it by compression securely and precisely at null point NP, within tube 151. This novel coaxial arrangement is useful for readily and precisely mounting an LVDT within a rigid tube, in tighter spaces than a known offset mounting bracket may allow. The clamp and LVDT can be compressed together by hand and pushed into the end of the tube for a positive friction fit. No fasteners are required and the assembly can be readily removed to access the LVDT. The discrete point of contact at NP around the circumference of coil assembly 111 minimizes error due to thermal expansion and contraction (thermal error), to levels that are substantially less than known mounting methods.

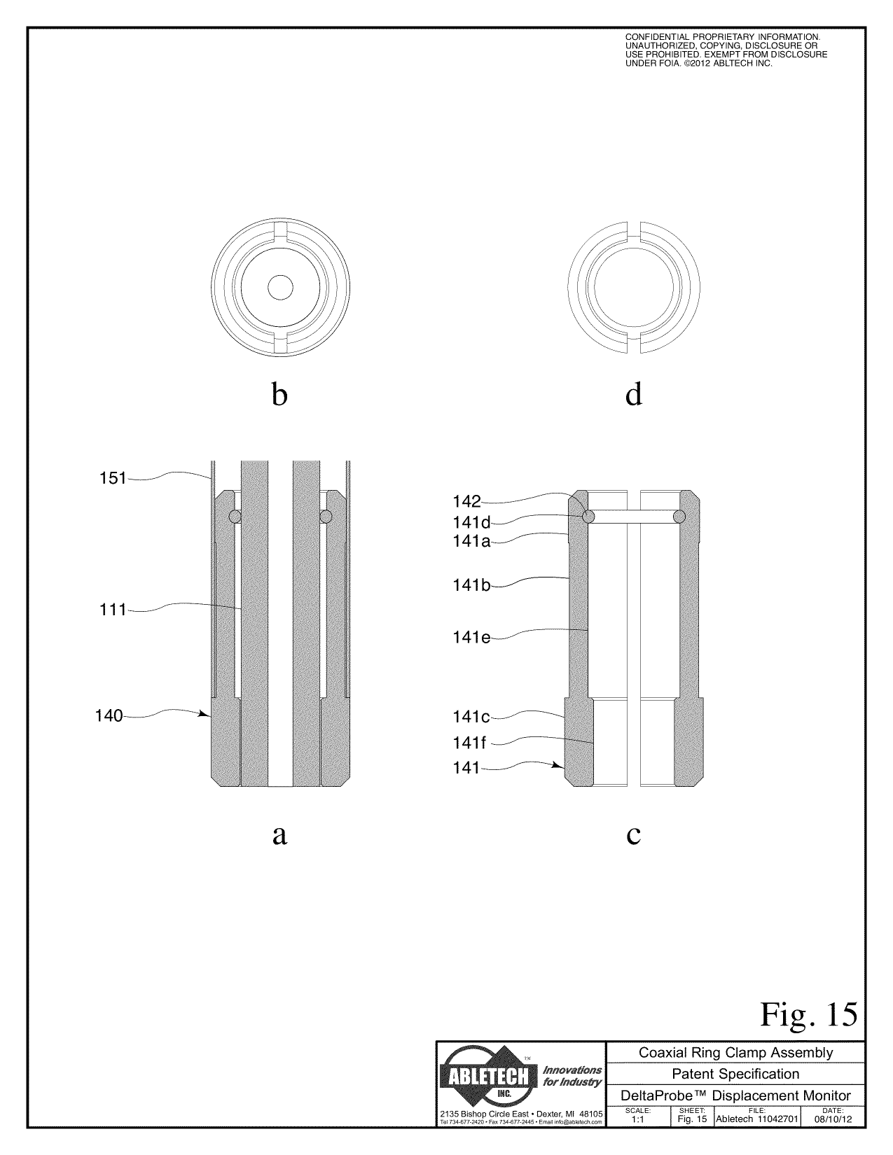

FIG. 15 shows details of the clamp. The clamping force is provided by the inside surface of tube 151 acting against outside top shoulder 141a, and inside recess 141d compressing o-ring 142 against the smooth cylindrical surface of coil assembly 111. The relatively short length of outside top shoulder 141a minimizes thermal error. The outside recess 141b, inside top surface 141e, and inside shoulder 141f keep the coil assembly centralized within the tube without exerting significant force on the coil assembly.

The split shell 141 can be machined or molded out of any suitable rigid material. In the present embodiment the split shell is machined out of Type I PVC plastic. The o-ring is a standard No. 15 rubber o-ring.

5.1.2. Extension

The novel extension 150 is a means to span the relatively long distance L1, to hold LVDT 110 in place so that connecting rod 120 and tip 123 can reach measured point MP. Thermal error can be significant because of the long distance L1. The tube 151 can be any rigid tube. The present embodiment uses unidirectional carbon fiber tube (CFT). This material is critical to the functioning of the device because of its low coefficient of thermal expansion (CTE), on the order of 1 ppm per degree F. More expensive, zero-CTE tube may also be used with even less thermal error.

The loop clamp 153 secures the top of tube 151 at reference point RP. The optional ferrule 151a can be used to attach two sections of tube together by gluing it within the tube sections. It is also made out of CFT. The optional reducer bushing 152 is used to attach optional housing 220 to the end of extension 150 for use of the extensometer 100 in basic water level probe 200 and total probe 400. It is glued over the end of tube 151. It can be machined or molded out of any suitable rigid material. The present embodiment uses a standard PVC fitting that is modified for a glue-fit over the end of tube 151.

5.1.3. Connecting Rod

The novel connecting rod 120 is heretofore unknown because tube 121 is made out of CFT. This minimizes thermal error to levels that are much less than that of known connecting rods that are usually made out of stainless steel, aluminum, brass or plastic. The threaded stud 122 is glued into the top end of tube 121. The optional tip 123 is any suitable tip that is glued into the bottom end of tube 121.

5.1.4. Bearing Collar

FIG. 13 shows heretofore-unknown effects of stiction, or stick-slip phenomena, in the use of an LVDT for water level measurement with a relatively small, lightweight float with little buoyancy. The stiction occurs between core 112, connecting rod 120 and bore 111a.

FIG. 14 shows the novel, optional bearing collar 130 with coaxial ring clamp 140 that has been shortened to work with the bearing collar. This collar is a means to reduce stiction between the top of core 112 and the surface of bore 111a. It can be used in place of, or in addition to autonomous vibrator 213. The collar reduces stiction by providing a bearing surface that centralizes the connecting rod 120 and core to eliminate contact between the top of the core and the surface of the bore over the entire stroke of the core.

In the present embodiment the annular space between the bearing surface and the connecting rod is 0.003″. The collar fits over the end of coil assembly 111 and is held in place by compression/friction against the coil assembly. The collar can be made out of any suitable material with low friction coefficient. This may include aluminum magnesium boride, PTFE (Teflon), or UHMW polyethylene.

### 5.2. Basic Probe

FIG. 2 shows extensometer 100 in use as a novel, “basic probe” 200 for monitoring water level from a reference point RP above a water body. The probe is suspended by loop clamp 153 at RP. In this use the connecting rod 120 is attached to novel float 210 and extension 150 is attached to novel, optional housing 220. The monitoring and power unit (MPU) measures and records the output of, and provides electrical power to, the probe.

5.2.1. Float

The tube 121 is glued into hole 212a. The cap 212 is threaded into the tapped end of vessel 211 to for a watertight seal. The cap can be machined or molded out of any material. The present embodiment uses a standard PVC cap, with minor modifications to fit this application.

The vessel 211 can be machined or molded out of any suitable material. The present embodiment is machined out of UHMW polyethylene of natural color. The volumetric CTE of UHMW is close to that of water, thereby minimizing thermal error. The natural color is translucent, thereby providing visibility of the vibrator power light 213a through the wall of the vessel.

Autonomous Vibrator

FIG. 13 shows heretofore-unknown effects of stiction, or stick-slip phenomena, in the use of an LVDT for water level measurement with a relatively small, lightweight float with little buoyancy. The stiction occurs between core 112, connecting rod 120 and bore 111a. The novel autonomous vibrator 213 is a means to overcome this stiction by periodically, very slightly, shaking the core and connecting rod loose from the minute sticking friction with the bore.

Wide ranges of vibration power, frequency, pulse duration and pulse frequency are possible. The selection of these parameters should strike an optimal balance between power consumption, effectiveness, and noise in the measurement. Lots of experimentation has led into the following optimal set of parameters: the power is 130 mW, the frequency is 9000 rpm, the pulse duration is 0.07 seconds and the pulse frequency is 7.07 seconds.

The vibrator proper consists of a battery 213a, control circuit 213b, vibrating motor 213c and power light 213d. The battery provides for autonomous run times of at least 24-hours. The control circuit is a known a stable circuit that runs the motor according to the above parameters. The motor is a known vibrating motor that is normally used for an alert in cell phones. The power light 213d indicates that the vibrator is working properly. It is bright when power is applied to the circuit and dims slightly when the motor is running. It is a known high intensity, low current light emitting diode.

5.2.2. Housing

Housing 220 restrains the float 210 and protects it during handling and positioning of probe 200. It also serves as a stilling well, to calm the water inside the housing for precise measurement of water level. The reducer bushing 221 is screwed into reducer bushing 152. The bushing is glued into coupling 222. The coupling is glued over the top end of tube 223. Tube 223 is clear, to allow for observation of power light 213d. Vent hole 223a provides for equalization of air pressure. The inlet cap 224 prevents float 210 from falling out. The inlet hole 224a allows water to enter the housing, and drain holes 224b allow water to drain from the housing when the float is blocking the inlet hole. The housing can be made from any rigid material. The present embodiment uses standard PVC pipe and fittings, as modified to fit this use.

### 5.3. Monitoring and Power Unit (MPU)

The monitoring and power unit measures and records time, output S (water level WL) from LVDT 110, air temperature Ta, water temperature Tw, and other ambient parameters Pa that may be relevant to the monitoring. These may include relative humidity, barometric pressure, wind speed, solar flux, etc. The MPU also provides power to the LVDT.

The MPU comprises a data logger 310 and power supply 320 within a rugged field case 330. The data logger is a high impedance device with differential inputs and low power consumption. This is necessary for sensitive measurements and long autonomy time. Any measurement and recording schedule is possible. The present embodiment measures the above parameters every second and records 1 minute, ten minute and hourly averages. The power supply consists of a rechargeable battery and regulator that can operate the data logger and LVDT 110 for at least 24-hours. Although not shown on other drawings, the MPU is used in every application of extensometer 100 throughout this specification.

### 5.4. Total Probe (TP)

FIG. 3 shows basic probe 200 in use as a novel “total probe” 300 for monitoring water level from a reference point RP beneath a water body. This is useful where there is no convenient fixed stable reference point above the water body. It this use the basic probe is suspended by loop clamp 153 point TC down into the water body, within support 410 that rests at reference point RP beneath the water body.

The support 410 consists of collar 411, tube 412, loop collar 413 and shoe 414. The collar 411 is a means to support basic probe 200 within support 410. Landing 411a is a resting point for loop clamp 153. Shoulder 411b rests on top of tube 412. The outside surface 411c fits loosely within tube 412. The inside surface 411d loosely centralizes basic probe 200 within support 410. Optional tapped hole(s) 411e and optional machine screws 410(f) restrain collar 411 within tube 412 as may be necessary for secure transport of total probe 300 as one package. The collar can be machined or molded out of any suitable material. This president embodiment is machined out of Type I PVC. FIG. 16 shows collar details.

The tube 412 is a means to span the relative distance from point TC to reference point RP. It also serves as a stilling well, to calm the water inside the tube for precise measurement. Thermal error can be significant over this long distance. The tube 412 can be any rigid tube. The present embodiment uses unidirectional carbon fiber tube (CFT). This material is critical to the functioning of the device because of its low coefficient of thermal expansion (CTE), on the order of 1 ppm per degree F. More expensive, zero-CTE tube may also be used with even less thermal error.

The optional ferrule 412b can be used to attach two sections of tube 412 together by gluing it within the tube sections. It is also made out of CFT. The equalizer holes 412c freely allow water in and out of the tube so the water level within the tube is always the same as the water level outside of the tube.

The loop collar 413 is a means to support the probe plumb, directly over the reference point RP. It fits loosely around the circumference of tube 412 so that it can exert no significant vertical force on the tube that may cause error. The collar can be secured to any suitable foundation, for example the floor of an under floor lagoon (FIG. 7) or the deck of mobile monitoring platform 600 (FIG. 8)

The shoe 414 is a means to securely rest the probe on the floor of a containment structure for precise monitoring of water level. The floor surface may be concrete, clay or any other soil, or a flexible membrane liner. Any suitable tip 414e can be screwed into large tapped hole 414d and be used for a given surface. The present embodiment uses a ¾×1″ stainless steel cap screw for the tip. Shoulder 414b supports tube 412 and outside surface 414a is glued within the tube. The inside surface 414c is conical to provide for good drainage and cleaning. Optional drain hole(s) 414f provide additional drainage as necessary. Instead of gluing, optional tapped holes 414g and optional machine screws 414h can be used to secure the shoe within the tube, making it readily removable for cleaning and service. The shoe can be machined or molded out of any suitable material. This president embodiment is machined out of PVC. FIG. 16 shows collar details.

### 5.5. Evaporation Probe (EP), on Surface

FIG. 4 shows basic probe 200, sans optional housing 220, in use as a novel “evaporation probe” 500 for monitoring water level within support 510 and hydraulically isolated pan 520. In this case the probe is resting on a surface. The support consists of collar 511, tube 512 and shoe 513 and is of similar construction to support 410. The pan is a cylindrical pan with straight sides. It has a clearance holes in the center for tube 512 and machine screws 522c. The pan can be any suitable metal or plastic pan. The present embodiment uses a standard 14″×3″ aluminum baking pan. Flanges 522 seal watertight to the tube and pan. The flanges can be machined or molded out of any material. The present embodiment is machined out of Type I PVC.

### 5.6. Evaporation Probe (EP), Suspended

FIG. 5 shows basic probe 200, sans optional housing 220, in use as a novel “evaporation probe” 500 for monitoring water level within support 510 and hydraulically isolated pan 520. In this case the probe is suspended from any suitable support. This probe is useful for measuring evaporation from a water body, by suspending it over, and partially into, the water body.

The hanger assembly 540 is a means to securely hang the evaporation probe 500 into the water body, without introducing forces on the basic probe 200 that may cause error. It consist of any suitable cable, chain or rope 541, split ring 542, tube 543, top flange 544 and connecting rods 545. The top end of the chain can be secured to any suitable foundation, for example the floor of an under floor lagoon (FIG. 7) or the deck of mobile monitoring platform 600 (FIG. 8).

The bottom end of the chain it is hooked to the split ring, made out of 3″× 3/16 stainless steel, that is hooked to holes in tube 543 Tube 543 is 1½″ stainless steel pipe that is screwed into the tapped 544a. The flange can be machined or molded out of any rigid material. The present embodiment uses Type I PVC. The screws 544c pass though clearance holes 544b and thread into that are tapped into the top of the connecting rods 545. The bottom taped holes of the connecting rods screw onto machine screws 522 to complete a secure hanger assembly.

### 5.7. Mobile Monitoring Platform (MMP)

FIG. 6 shows a novel mobile monitoring platform 600. This platform is a means to safely and securely deploy the total probe 400 and evaporation probe 500 from the shore into an open water body. The platform is mechanically isolated from the total probe so minor disturbances do not cause error in the sensitive measurement. It consists of a roadworthy trailer 610, deck for personnel, bracket for the total probe, and arm for hanging the evaporation probe.

The trailer and deck are hinged at 610a and 620a to provide a level platform on any side slope up to 1v:2h. The support post(s) 610b and bracket(s) 6290b secure the deck in place. The trailer may include an optional tank, pump and hose 610c for onsite decon, and a tool box 610d. The deck includes an OSHA railing 620c for personnel safety.

Bracket 630 is a means to securely support the probe plumb, directly over the reference point RP. This device is useful where RP is on the side slope of a slippery surface such as a flexible membrane liner, where the total probe is prone to slide down-slope. It consists of an adjustable ball mount, attached securely to the railing at one end, and two loop collars 413 that are spaced at least 15″ apart. The ball mount can be adjusted such that the two loop collars are directly over each other. The loop collar fits loosely around the circumference of tube 412 so that they can exert no significant vertical force on the tube that may cause error.

The hanging arm 640 is a means to suspend the evaporation probe over, and partially into, the water body. It is designed to get the probe as far away from the MMP as possible, to reduce the effects of the MMP on the sensitive evaporation measurement. It is hinged for mechanical advantage to position the probe, and so it can be stowed for compact transport.

### 5.8. TP and EP in Under Floor Lagoon

FIG. 7 shows total probe 400 and evaporation probe 500 deployed in an under floor lagoon 700. From this drawing it is evident that the total probe and evaporation probe are useful for precisely monitoring water level and evaporation in confined, remote places.

### 5.9. TP, EP and MMP in Open Water Lagoon

FIG. 8 shows total probe 400 and evaporation probe 500 deployed in an open water lagoon. From this drawing it is evident that the total probe and evaporation probe are useful for precisely monitoring water level and evaporation in an open water body where there is no suitable reference point over the water body.

### 5.10. EP in Class A NWS Evaporation Pan

FIG. 9 shows the evaporation probe 500, sans pan 520, on a base in a known Hargreaves Class A NWS evaporation pan 550. This arrangement, together with MPU 300 provides for continuous, real time monitoring of water level in the pan to the nearest 0.001. This is superior to the known practice of reading the water level manually with a water level micrometer to the nearest 0.01″.

### 5.11. Model Containment Structure

FIG. 10 shows a model containment structure 700. This figure shows how to determine displacement due to seepage (specific discharge) through liner system 720 by measuring total displacement Dt with the total probe 400, and evaporation displacement De, with evaporation probe 500.

### 5.12. Water Level Versus Time

FIG. 11 shows water level versus time in a model containment structure 700 at a maximum allowable seepage (specific discharge) of 1E-6 cm/sec. This graph obviates the necessity for measurement precision on the order of 0.001″ to make a valid determination of seepage displacement Ds during short observation period of about 8 hours.

### 5.13. LVDT and Water Level

FIG. 12 shows a known LVDT and float in use to measure water level. This drawing may be used in the background and prior art sections of the formal patent application.

### 5.14. Stiction and Vibration

FIG. 13 shows heretofore-unknown effects of stiction, or stick-slip phenomena, in the use of an LVDT for water level measurement with a relatively small, lightweight float with little buoyancy. It may be used in the background and prior art sections of the formal patent application. See Sections 1.1.4 and 1.2.1 for more info.

I claim:

1. An extensometer probe 100 and system comprised of a known linear variable differential transformer (LVDT) assembly 110 and connecting rod assembly 120, novel coaxial clamp assembly 140, and novel extension tube assembly 150; said probe useful for reducing thermal error, precisely monitoring displacement over relatively long distances, and deployment of an LVDT in tight spaces such as a well or borehole; said probe useful for monitoring convergence or dilation in tunnels, bridges, buildings and other structures; and said probe useful for monitoring water level in environmental containment structures and evaporation within a hydraulically isolated evaporation pan.

2. A float 210 for monitoring the position of the free surface of a liquid with an LVDT; said float comprising a vessel 211, cap 212, and autonomous vibrator assembly 213 for reducing effects of bubbles, transient surface tension, and friction of the LVDT core 112 and connecting rod against the LVDT bore 111a.

3. A total probe 400 for monitoring water level with respect to the bottom of a containment structure 700.

4. An evaporation probe 500 for monitoring water level within a hydraulically isolated evaporation pan 520.

5. A mobile monitoring platform 600 for deployment of the total probe 400 and evaporation probe 500 within a containment structure 700.

6. A system comprised of the total probe, evaporation probe and monitoring unit 300 for directly measuring and monitoring seepage, or specific discharge, of water from an animal waste impoundment or other containment structure.
